(19) United States
(12) Patent Application Publication
(10) Pub. No.: US 2026/0226957 A1
(43) Pub. Date: Aug. 6, 2026

(54) SHOCK ABSORBER, SHOCK ABSORBER MANUFACTURING METHOD, VALVE, AND VALVE MANUFACTURING METHOD

(71) Applicant: Hitachi Astemo, Ltd., Ibaraki (JP)

(72) Inventor: Kumi HASHIMOTO, Hitachinaka-shi (JP)

(21) Appl. No.: 18/878,174

(22) PCT Filed: Jun. 29, 2023
(86) PCT No.: PCT/JP2023/024175

§ 371 Date: Dec. 23, 2024

(30) Foreign Application Priority Data
Jul. 4, 2022 (JP) 2022-107764

(51) Int. Cl. F16F 9/348; F16F 9/32

(52) U.S. Cl. CPC F16F 9/348; F16F 9/3271; F16F 2230/0041

(57) ABSTRACT

A shock absorber includes: a cylinder; a piston provided inside the cylinder; a rod which has one end connected to the piston and the other end extending from the cylinder; and a body valve which divides the inside of the cylinder into two chambers. The body valve includes a valve body which has a working fluid passage, at least one disk-shaped valve member that opens and closes the working fluid passage, a restricting member that is provided on the opposite side to the valve body in the valve member and thicker than the valve member, and a pin member that is disposed on the inner peripheries of the valve member and the restricting member, has a flange portion provided at one end and a crimped portion provided at the other end, and arranges the valve body, the valve member, and the restricting member in an axial direction to integrate them.

### TECHNICAL FIELD

The present invention relates to a shock absorber, a shock absorber manufacturing method, a valve, and a valve manufacturing method.

Priority is claimed on Japanese Patent Application No. 2022-107764, filed Jul. 4, 2022, the content of which is incorporated herein by reference.

### BACKGROUND ART

There is known a hydraulic shock absorber having a structure in which a pin member having a flange portion on one side is inserted through a valve body and a valve member and the other side of the pin member is crimped to integrate the valve body and the valve member with the pin member (for example, see Patent Documents 1 and 2 below).

### CITATION LIST

### Patent Document

Patent Document 1: Japanese Patent No. 5397640
Patent Document 2: Japanese Patent No. 2642109

### SUMMARY OF INVENTION

### Technical Problem

In a structure in which the pin member is crimped, there is a possibility that stable damping force characteristics may not be obtained.

Therefore, an object of the present invention is to provide a shock absorber, a shock absorber manufacturing method, a valve, and a valve manufacturing method capable of obtaining stable damping force characteristics.

### Solution to Problem

In order to achieve the aforementioned objects, the present invention adopts the following aspects.

A first aspect according to the present invention is a shock absorber including: a cylinder; a piston which is provided inside the cylinder; a rod which has one end connected to the piston and another end extending from the cylinder; and a body valve which divides an inside of the cylinder into two chambers, wherein the body valve includes a valve body which has a working fluid passage, at least one disk-shaped valve member that opens and closes the working fluid passage, a restricting member that is provided on an opposite side to the valve body in the valve member and thicker than the valve member, and a pin member that is disposed on inner peripheries of the valve member and the restricting member, has a flange portion provided at one end and a crimped portion provided at another end, and arranges the valve body, the valve member, and the restricting member in an axial direction to integrate them, and wherein an outer diameter of a facing portion facing the restricting member in the pin member is smaller than that of a part other than the facing portion in the axial direction of the pin member.

A second aspect according to the present invention is a method of manufacturing a shock absorber including a cylinder, a piston provided inside the cylinder, and a body valve dividing an inside of the cylinder into two chambers, the body valve including a valve body having a working fluid passage, at least one disk-shaped valve member opening and closing the working fluid passage, a restricting member provided on an opposite side to the valve body in the valve member and thicker than the valve member, and a pin member disposed on inner peripheries of the valve member and the restricting member, having a flange portion provided at one end and a crimped portion provided at another end, arranging the valve body, the valve member, and the restricting member in an axial direction to integrate them, the method including: a residual axial force applying step of applying a residual axial force to the valve body and the valve member; a pressing step of pressing the restricting member toward the pin member; and a crimping step of forming the crimped portion by crimping.

A third aspect according to the present invention is a valve used in a shock absorber, including: a valve body which has a working fluid passage; at least one disk-shaped valve member that opens and closes the working fluid passage; a restricting member that is provided on an opposite side to the valve body in the valve member and thicker than the valve member; and a pin member that is disposed on inner peripheries of the valve member and the restricting member, has a flange portion provided at one end and a crimped portion provided at another end, and arranges the valve body, the valve member, and the restricting member in an axial direction to integrate them, wherein a gap between the restricting member and the pin member is smaller than a gap between the valve body and the pin member.

A fourth aspect according to the present invention is a method of manufacturing a valve used in a shock absorber and including a valve body having a working fluid passage, at least one disk-shaped valve member opening and closing the working fluid passage, a restricting member provided on an opposite side to the valve body in the valve member and thicker than the valve member, and a pin member disposed on inner peripheries of the valve member and the restricting member, having a flange portion provided at one end and a crimped portion provided at another end, and arranging the valve body, the valve member, and the restricting member in an axial direction to integrate them, the method including: a residual axial force applying step of applying a residual axial force to the valve body and the valve member; a pressing step of pressing the restricting member toward the pin member; and a crimping step of forming the crimped portion by crimping.

### Advantageous Effects of Invention

According to each aspect of the present invention, it is possible to obtain stable damping force characteristics.

### BRIEF DESCRIPTION OF DRAWINGS

FIG. 1 A cross-sectional view showing a shock absorber according to a first embodiment of the present invention. That is, a cross-sectional view of a shock absorber taken along a cross section including a central axis CL of the shock absorber, where CL indicates the central axis of the shock absorber.

FIG. 2 A cross-sectional view showing a body valve of the first embodiment taken along a cross section including the central axis CL.

FIG. 3 A plan view showing a washer before assembly in the body valve of the first embodiment.

FIG. 4 A cross-sectional view showing a washer before assembly in the body valve of the first embodiment taken along line A-A of FIG. 3.

FIG. 5 A cross-sectional view showing a state after a shaft portion inserting step and before a clamping step in the method of manufacturing the shock absorber and the body valve of the first embodiment taken along a cross section including the central axis CL.

FIG. 6 A cross-sectional view showing a clamping step, a residual axial force applying step, and a pressing step in the method of manufacturing the shock absorber and the body valve of the first embodiment taken along a cross section including the central axis CL.

FIG. 7 A partially enlarged cross-sectional view of part B in FIG. 6 showing a state after a pressing step and before a crimping step in the method of manufacturing the shock absorber and the body valve of the first embodiment.

FIG. 8 A partially enlarged cross-sectional view showing a main part of the body valve of the first embodiment and corresponding to FIG. 7.

FIG. 9 A cross-sectional view showing a clamping step, a residual axial force applying step, and a pressing step in a first modified example of the method of manufacturing the shock absorber and the body valve of the first embodiment taken along a cross section including the central axis CL.

FIG. 10 A side view showing a clamp member used in a first modified example of the method of manufacturing the shock absorber and the body valve of the first embodiment.

FIG. 11 A plan view showing a washer before assembly in a second modified example of the body valve of the first embodiment.

FIG. 12 A cross-sectional view showing a washer before assembly in the second modified example of the body valve of the first embodiment taken along line C-C of FIG. 11.

FIG. 13 A plan view showing a washer before assembly in a third modified example of the body valve of the first embodiment.

FIG. 14 A cross-sectional view showing a washer before assembly in the third modified example of the body valve of the first embodiment taken along line D-D of FIG. 13.

FIG. 15 A cross-sectional view showing a washer before assembly in a fourth modified example of the body valve of the first embodiment and corresponding to FIG. 14.

FIG. 16 A cross-sectional view showing a body valve of a shock absorber according to a second embodiment of the present invention taken along a cross section including the central axis CL.

FIG. 17 A cross-sectional view showing a residual axial force applying step and a pressing step in the method of manufacturing the shock absorber and the body valve of the second embodiment taken along a cross section including the central axis CL.

### DESCRIPTION OF EMBODIMENTS

### First Embodiment

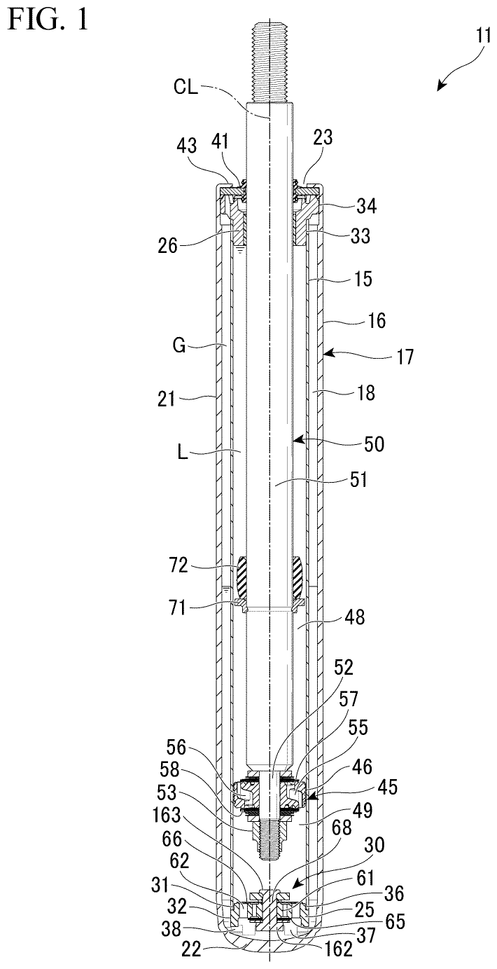

A first embodiment will be described with reference to FIGS. 1 to 15. Furthermore, in each drawing, the reference character CL indicates the central axis of the shock absorber. The same applies to the other embodiments and modified examples.

FIG. 1 shows a shock absorber 11 of the first embodiment. The shock absorber 11 is a shock absorber used in a suspension device of a vehicle such as an automobile or a railroad car. The shock absorber 11 is specifically a shock absorber used in a strut-type suspension of an automobile. The shock absorber 11 includes a cylinder 17 having an inner cylinder 15 and an outer cylinder 16.

The inner cylinder 15 has a cylindrical shape. The outer cylinder 16 has a bottomed cylindrical shape. The outer cylinder 16 has a larger diameter than the inner cylinder 15 and is provided on the outer peripheral side of the inner cylinder 15. Thus, the shock absorber 11 is a twin-cylinder type shock absorber. A reservoir chamber 18 (chamber) is formed between the outer cylinder 16 and the inner cylinder 15.

The outer cylinder 16 is an integrally molded product made of a single metal member. The outer cylinder 16 has a side wall portion 21 and a bottom portion 22. The side wall portion 21 has a cylindrical shape. The bottom portion 22 has a disk shape and closes one end portion side of the side wall portion 21 in the axial direction. The outer cylinder 16 has an opening 23 on the opposite side to the bottom portion 22 in the side wall portion 21.

The shock absorber 11 includes a valve body 25 and a rod guide 26. The valve body 25 has an annular shape, is provided at one end portion of the inner cylinder 15 in the axial direction, and is placed on the bottom portion 22 of the outer cylinder 16. The rod guide 26 has an annular shape and is provided at an end portion on the opposite side to the valve body 25 in the axial direction of the inner cylinder 15 and the outer cylinder 16.

The valve body 25 constitutes a body valve 30 (valve). The valve body 25 has a small outer diameter portion 31 and a large outer diameter portion 32 having a larger diameter than the small outer diameter portion 31 at the outer peripheral portion. The rod guide 26 also has a small outer diameter portion 33 and a large outer diameter portion 34 having a larger diameter than the small outer diameter portion 33 at the outer peripheral portion.

One end portion of the inner cylinder 15 in the axial direction is fitted to the small outer diameter portion 31 of the valve body 25. The inner cylinder 15 is placed on the bottom portion 22 of the outer cylinder 16 via the valve body 25. The other end portion of the inner cylinder 15 in the axial direction is fitted to the small outer diameter portion 33 of the rod guide 26. The large outer diameter portion 32 of the rod guide 26 is fitted to the side wall portion 21 of the outer cylinder 16. Thus, the inner cylinder 15 is fitted to the side wall portion 21 of the outer cylinder 16 via the rod guide 26. In this state, the inner cylinder 15 is positioned in the radial direction relative to the outer cylinder 16.

The valve body 25 has a partition portion 36 and a leg portion 37.

The partition portion 36 has a perforated disk shape. The partition portion 36 has a part on the side of the small outer diameter portion 31 in the axial direction of the large outer diameter portion 32 and the small outer diameter portion 31.

The leg portion 37 protrudes from the outer peripheral side of the partition portion 36 along the axial direction of the partition portion 36. The leg portion 37 has an annular shape. The leg portion 37 has a part on the opposite side to the small outer diameter portion 31 in the axial direction of the large outer diameter portion 32. A passage groove 38 is formed at a position on the opposite side to the partition portion 36 in the axial direction of the leg portion 37. The passage groove 38 penetrates the leg portion 37 in the radial direction of the leg portion 37. The leg portion 37 has a plurality of passage grooves 38 of the same shape formed at equal intervals in the circumferential direction.

The leg portion 37 of the valve body 25 comes into contact with the bottom portion 22 of the outer cylinder 16. The space between the valve body 25 and the bottom portion 22 of the outer cylinder 16 communicates with the space between the inner cylinder 15 and the outer cylinder 16 via the passage groove 38. Accordingly, the space between the valve body 25 and the bottom portion 22 constitutes the reservoir chamber 18 as in the space between the inner cylinder 15 and the outer cylinder 16.

The shock absorber 11 includes a blocking member 41. The blocking member 41 has an annular shape and is provided on the opposite side to the bottom portion 22 in the rod guide 26. The blocking member 41 is fitted to the inner peripheral portion of the side wall portion 21 of the outer cylinder 16. A locking portion 43 is formed at the end portion on the opposite side to the bottom portion 22 in the axial direction of the side wall portion 21. The locking portion 43 is formed by plastically deforming the cylindrical side wall portion 21 radially inward by crimping such as curling. The blocking member 41 is sandwiched between the locking portion 43 and the rod guide 26. The blocking member 41 blocks the opening 23 of the outer cylinder 16, and is an oil seal.

The shock absorber 11 includes a piston 45. A synthetic resinous sliding member 46 is attached to the outer peripheral portion of the piston 45. The piston 45 is provided to be slidable on the inner cylinder 15 of the cylinder 17 via the sliding member 46. The piston 45 divides the inside of the inner cylinder 15 into two chambers, a first chamber 48 and a second chamber 49 (chamber). The first chamber 48 is provided between the rod guide 26 and the piston 45 inside the inner cylinder 15. The second chamber 49 is provided between the valve body 25 and the piston 45 inside the inner cylinder 15. The second chamber 49 is divided from the reservoir chamber 18 by the valve body 25. In other words, the valve body 25 of the body valve 30 divides the inside of the cylinder 17 into two chambers, the second chamber 49 and the reservoir chamber 18.

In the cylinder 17, the first chamber 48 and the second chamber 49 are filled with an oil L as a working fluid. Further, in the cylinder 17, the reservoir chamber 18 is filled with a gas G and an oil Las a working fluid.

The shock absorber 11 includes a rod 50.

The rod 50 has a main shaft portion 51 and an attachment shaft portion 52.

The outer diameter of the attachment shaft portion 52 is smaller than the outer diameter of the main shaft portion 51. The attachment shaft portion 52 is provided at one end of the main shaft portion 51 in the axial direction.

In the rod 50, the attachment shaft portion 52 at one end in the axial direction is connected to the piston 45, and the main shaft portion 51 on the other side in the axial direction extends from the outer cylinder 16 of the cylinder 17 to the outside via the opening 23. The piston 45 is connected to the attachment shaft portion 52 of the rod 50 by a nut 53. The main shaft portion 51 of the rod 50 passes through the rod guide 26 and the blocking member 41 and extends from the inner cylinder 15 and the outer cylinder 16 to the outside. The main shaft portion 51 of the rod 50 is guided by the rod guide 26 and moves in the axial direction together with the piston 45 relative to the inner cylinder 15 and the outer cylinder 16. The blocking member 41 blocks the gap between the rod 50 and the opening 23 of the outer cylinder 16 to thereby restrict the oil L in the inner cylinder 15 and the gas G and the oil L in the reservoir chamber 18 from leaking to the outside.

The piston 45 has a passage 55 and a passage 56 that penetrate in the axial direction. The passages 55 and 56 are capable of communicating between the first chamber 48 and the second chamber 49. The passages 55 and 56 are passages through which the oil L flows.

The shock absorber 11 includes a disk valve 57 and a disk valve 58.

The disk valve 57 has an annular shape and is provided on the opposite side to the bottom portion 22 in the axial direction of the piston 45. The disk valve 57 comes into contact with the piston 45 to block the passage 55. The passage 55 is always open to the second chamber 49.

The disk valve 58 has an annular shape and is provided on the side of the bottom portion 22 in the axial direction of the piston 45. The disk valve 58 comes into contact with the piston 45 to block the passage 56. The passage 56 is always open to the first chamber 48.

The disk valves 57 and 58 are connected to the attachment shaft portion 52 of the rod 50 together with the piston 45.

The direction in which the rod 50 increases its amount of entry into the inner cylinder 15 and the outer cylinder 16, that is, into the cylinder 17 is the compression side in which the overall length of the shock absorber 11 is decreased. The disk valve 57 opens the passage 55 when the rod 50 moves toward the compression side, the piston 45 moves in the direction of narrowing the second chamber 49, and the pressure in the second chamber 49 becomes higher than the pressure in the first chamber 48 by a predetermined value or more. Accordingly, the oil L of the second chamber 49 flows to the first chamber 48 via the passage 55. The disk valve 57 is a damping valve that generates a damping force at that time. At least one of the piston 45 and the disk valve 57 has a fixed orifice (not shown). This fixed orifice allows communication between the second chamber 49 and the first chamber 48 via the passage 55 even when the disk valve 57 is in the most blocked state of the passage 55.

The direction in which the rod 50 increases its amount of protrusion into the inner cylinder 15 and the outer cylinder 16, that is, into the cylinder 17 is the extension side in which the overall length of the shock absorber 11 is increased. The disk valve 58 opens the passage 56 when the rod 50 moves toward the extension side, the piston 45 moves in the direction of narrowing the first chamber 48, and the pressure in the first chamber 48 becomes higher than the pressure in the second chamber 49 by a predetermined value or more. Accordingly, the oil L of the first chamber 48 flows to the second chamber 49 via the passage 56. The disk valve 58 is a damping valve that generates a damping force at that time. At least one of the piston 45 and the disk valve 58 has a fixed orifice (not shown). This fixed orifice allows communication between the first chamber 48 and the second chamber 49 via the passage 56 even when the disk valve 58 is in the most blocked state of the passage 56.

The valve body 25 has a passage 61 and a passage 62 (working fluid passage) at the partition portion 36. The passages 61 and 62 penetrate the partition portion 36 in the axial direction of the partition portion 36. The passages 61 and 62 are capable of communicating between the second chamber 49 and the reservoir chamber 18. The oil L flows through the passages 61 and 62.

The body valve 30 includes a disk valve 65, a disk valve 66 (valve member), and a pin member 68.

The disk valve 65 is provided on the side of the bottom portion 22 in the axial direction of the valve body 25. The disk valve 65 has an annular shape and comes into contact with the valve body 25 to block the passage 61.

The disk valve 66 is provided on the opposite side to the bottom portion 22 in the axial direction of the valve body 25. The disk valve 66 has an annular shape and comes into contact with the valve body 25 to block the passage 62.

The pin member 68 connects the disk valves 65 and 66 to the valve body 25 to integrate them together.

The body valve 30 which includes the valve body 25, the disk valves 65 and 66, the pin member 68, and the like divides the cylinder 17 into two chambers, the second chamber 49 and the reservoir chamber 18. The passage 61 always communicates with the second chamber 49, and the passage 62 always communicates with the reservoir chamber 18.

In the shock absorber 11, when the rod 50 moves toward the compression side, the piston 45 moves in the direction of narrowing the second chamber 49, and the pressure in the second chamber 49 becomes higher than the pressure in the reservoir chamber 18 by a predetermined value or more, the disk valve 65 of the body valve 30 opens the passage 61. Accordingly, the oil L of the second chamber 49 flows to the reservoir chamber 18 via the passage 61. At that time, the disk valve 65 generates a damping force. The disk valve 65 is a damping valve.

In the shock absorber 11, when the rod 50 moves toward the extension side, the piston 45 moves in the direction of narrowing the first chamber 48, and the pressure in the second chamber 49 becomes lower than the pressure in the reservoir chamber 18, the disk valve 66 of the body valve 30 opens the passage 62. Accordingly, the oil L of the reservoir chamber 18 flows to the second chamber 49 via the passage 62. At that time, the disk valve 66 allows the oil L to flow from the reservoir chamber 18 into the second chamber 49 without generating any substantial damping force. The disk valve 66 is a suction valve.

A locking member 71 is fixed to the rod 50 between the piston 45 and the rod guide 26. The rod 50 has a buffer member 72 between the locking member 71 and the rod guide 26. The buffer member 72 comes into contact with the locking member 71. When the rod 50 moves to a predetermined position on the extension side, the buffer member 72 comes into contact with the rod guide 26 to absorb the impact.

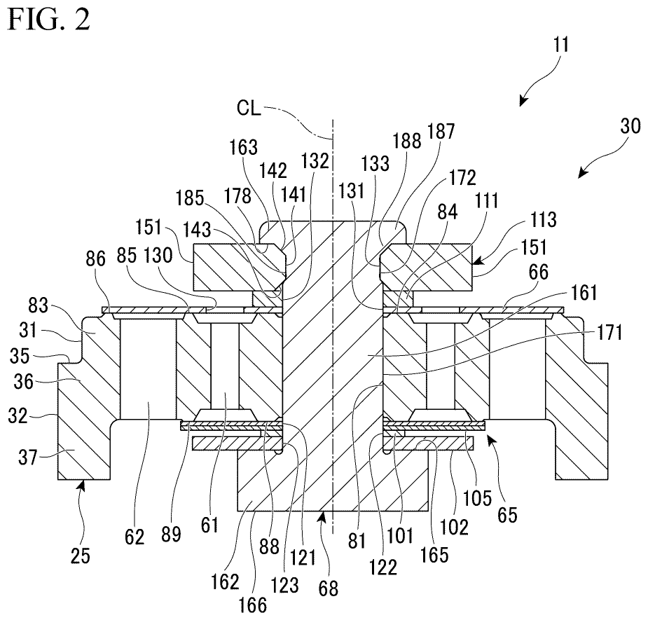

The valve body 25 is made of metal. The valve body 25 has a perforated disk shape. In the valve body 25, an inner peripheral surface 81 shown in FIG. 2 and located in the radial center thereof is a cylindrical surface.

The partition portion 36 of the valve body 25 has a main body portion 83, a fixed seat portion 84, an inner seat portion 85, an outer seat portion 86, a fixed seat portion 88, and a seat portion 89.

The main body portion 83 has a perforated disk shape. An axially intermediate part of the inner peripheral surface 81 is disposed on the main body portion 83.

The fixed seat portion 84, the inner seat portion 85, and the outer seat portion 86 are all provided on the opposite side to the leg portion 37 in the axial direction of the main body portion 83.

The fixed seat portion 84 has an annular shape that surrounds the inner peripheral surface 81 from the outside in the radial direction of the inner peripheral surface 81. The fixed seat portion 84 protrudes from the main body portion 83 toward the opposite side to the leg portion 37 along the axial direction of the main body portion 83.

The inner seat portion 85 has an annular shape that surrounds the fixed seat portion 84 from the outside in the radial direction of the main body portion 83. The inner seat portion 85 is separated from the fixed seat portion 84 in the radial direction of the main body portion 83. The inner seat portion 85 protrudes from the main body portion 83 toward the opposite side to the leg portion 37 in the axial direction of the main body portion 83.

The outer seat portion 86 has an annular shape that surrounds the inner seat portion 85 from the outside in the radial direction of the main body portion 83. The outer seat portion 86 is separated from the inner seat portion 85 in the radial direction of the main body portion 83. The outer seat portion 86 protrudes from the main body portion 83 toward the opposite side to the leg portion 37 along the axial direction of the main body portion 83.

The fixed seat portion 84, the inner seat portion 85, and the outer seat portion 86 are aligned with each other in height position with respect to the protruding tip surfaces in the axial direction of the valve body 25.

The fixed seat portion 88 and the seat portion 89 are both provided on the opposite side to the fixed seat portion 84, the inner seat portion 85, and the outer seat portion 86 in the axial direction of the main body portion 83.

The fixed seat portion 88 has an annular shape that surrounds the inner peripheral surface 81 from the outside in the radial direction of the inner peripheral surface 81. The fixed seat portion 88 protrudes from the main body portion 83 toward the opposite side to the fixed seat portion 84 in the axial direction of the main body portion 83.

The seat portion 89 has an annular shape that surrounds the fixed seat portion 88 from the outside in the radial direction of the main body portion 83. The seat portion 89 is separated from the fixed seat portion 88 in the radial direction of the main body portion 83. The seat portion 89 protrudes from the main body portion 83 toward the opposite side to the inner seat portion 85 in the axial direction of the main body portion 83.

The height position of the protruding tip surface of the seat portion 89 is slightly higher than the height position of the protruding tip surface of the fixed seat portion 88 in the axial direction of the valve body 25.

One end of the passage 61 opens between the fixed seat portion 84 and the inner seat portion 85, and the other end thereof opens between the fixed seat portion 88 and the seat portion 89. The plurality of passages 61 are formed in the main body portion 83 at equal interval in the circumferential direction of the valve body 25.

One end of the passage 62 opens between the inner seat portion 85 and the outer seat portion 86, and the other end thereof opens between the seat portion 89 and the leg portion 37. The plurality of passages 62 are formed in the main body portion 83 at equal intervals in the circumferential direction of the valve body 25.

The passage 61 is located between the inner peripheral surface 81 and the passage 62 in the radial direction of the valve body 25.

The body valve 30 includes a disk valve 65, a disk 101, and a suppressor disk 102 on the side of the leg portion 37 in the axial direction of the partition portion 36 in this order from the partition portion 36 in the axial direction.

The disk valve 65 includes a plurality of disks, specifically, two disks 105 of the same shape. The disk 101, the suppressor disk 102, and the plurality of disks 105 are all made of metal and have all perforated circular flat plate shapes, that is, disk shapes.

The outer diameter of the disk 105 is slightly larger than the outer diameter of the seat portion 89. In the disk 105, an inner peripheral surface 121 which is located in the radial center thereof is a cylindrical surface. In the disk valve 65, the disk 105 which is closest to the partition portion 36 in the axial direction among the plurality of disks 105 comes into contact with the fixed seat portion 88 and the seat portion 89. The disk valve 65 opens and closes the passage 61 in such a manner that the disk 105 moves away from and into contact with the seat portion 89.

The outer diameter of the disk 101 is smaller than the outer diameter of the disk 105. In the disk 101, an inner peripheral surface 122 which is located in the radial center thereof is a cylindrical surface.

The outer diameter of the suppressor disk 102 is larger than the outer diameter of the disk 101 and is slightly smaller than the outer diameter of the disk 105. In the suppressor disk 102, an inner peripheral surface 123 which is located in the radial center thereof is a cylindrical surface. The thickness of the suppressor disk 102 is thicker than that of the disk 105. The rigidity of the suppressor disk 102 is higher than that of the disk 105.

The body valve 30 includes a disk valve 66, a disk 111, and a washer 113 (restricting member) on the opposite side to the leg portion 37 in the axial direction of the partition portion 36 in order from the partition portion 36 in the axial direction. The disk valve 66 and the disk 111 are both made of metal and both have perforated circular flat plate shapes, that is, disk shapes.

The outer diameter of the disk valve 66 is slightly larger than the outer diameter of the outer seat portion 86. The disk valve 66 includes a passage hole 130 that penetrates the disk valve 66 in the axial direction of the disk valve 66. The plurality of passage holes 130 are formed in the disk valve 66 at equal intervals in the circumferential direction of the disk valve 66. In the disk valve 66, an inner peripheral surface 131 which is located in the radial center thereof is a cylindrical surface. The disk valve 66 comes into contact with the fixed seat portion 84, the inner seat portion 85, and the outer seat portion 86. In this state, the plurality of passage holes 130 of the disk valve 66 are arranged between the fixed seat portion 84 and the inner seat portion 85 in the radial direction of the disk valve 66. The disk valve 66 opens and closes the passage 62 by moving away from and into contact with the outer seat portion 86.

The outer diameter of the disk 111 is smaller than the outer diameter of the disk valve 66. In the disk 111, an inner peripheral surface 132 which is located in the radial center thereof is a cylindrical surface.

The diameter of the inner peripheral surface 81 of the valve body 25, the diameter of the inner peripheral surface 121 of the disk 105, the diameter of the inner peripheral surface 122 of the disk 101, the diameter of the inner peripheral surface 123 of the suppressor disk 102, the diameter of the inner peripheral surface 131 of the disk valve 66, and the diameter of the inner peripheral surface 132 of the disk 111 are all equal.

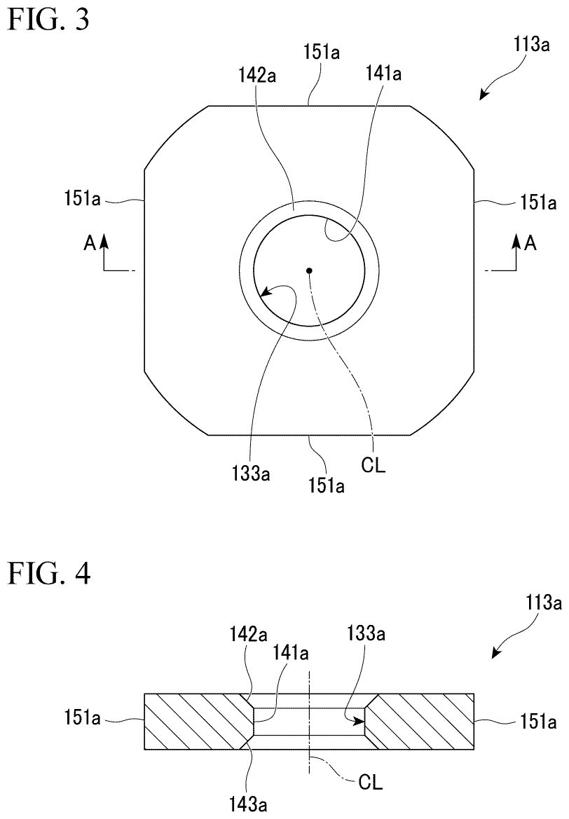

FIGS. 3 and 4 show a washer 113a before being assembled to the body valve 30 shown in FIG. 2. When the washer 113a is assembled to the body valve 30, the washer is plastically deformed to become the washer 113 shown in FIG. 2.

As shown in FIG. 3, the washer 113a has a rectangular flat plate shape with a hole. The washer 113a is made of metal. In the washer 113a, an inner peripheral surface 133a which is located at the center thereof has a circular shape when viewed from the thickness direction of the washer 113a. As shown in FIG. 4, the inner peripheral surface 133a has a small diameter portion 141a, a large diameter portion 142a, and a large diameter portion 143a.

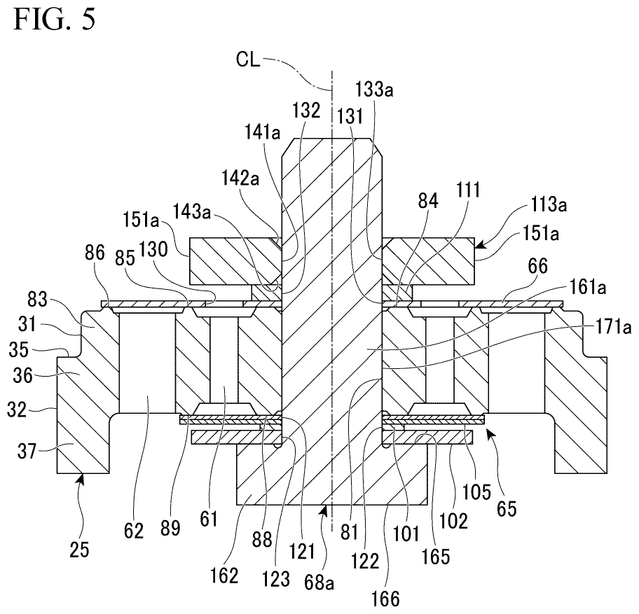

The small diameter portion 141a is provided at the center of the inner peripheral surface 133a in the thickness direction of the washer 113a. The small diameter portion 141a is a cylindrical surface. The central axis of the small diameter portion 141a is aligned along the thickness direction of the washer 113a. As shown in FIG. 5, the diameter of the small diameter portion 141a is equal to the diameter of the inner peripheral surface 81 of the valve body 25.

As shown in FIG. 4, the large diameter portion 142a spreads from one end portion of the small diameter portion 141a in the axial direction in a direction away from the small diameter portion 141a in the axial direction while increasing in diameter. The large diameter portion 142a is a tapered surface.

The large diameter portion 143a spreads from the end portion on the opposite side to the large diameter portion 142a in the axial direction of the small diameter portion 141a in a direction away from the small diameter portion 141a in the axial direction while increasing in diameter. The large diameter portion 143a is a tapered surface.

The small diameter portion 141a and the large diameter portions 142a and 143a have the same central axis. This central axis is the central axis of the inner peripheral surface 133a. The inner peripheral surface 133a is located at the center in the radial direction of the washer 113a. The central axis of the inner peripheral surface 133a coincides with the central axis of the washer 113a. The axial direction of the washer 113a coincides with the thickness direction of the washer 113a. The small diameter portion 141a is located at the center in the axial direction of the washer 113a.

The inner periphery of the washer 113a has a small diameter portion 141a and large diameter portions 142a and 143a which have a larger diameter than the small diameter portion 141a and are provided at positions different from the small diameter portion 141a in the axial direction of the washer 113a.

A pressing surface 151a is formed on the outer peripheral portion of the washer 113a. The pressing surface 151a is a flat surface spreading perpendicularly to the radial direction of the washer 113a. As shown in FIG. 3, the washer 113a has the plurality of, specifically, four pressing surfaces 151a of the same shape formed at equal intervals in the circumferential direction. The four pressing surfaces 151a are spaced at equal distances from the central axis of the washer 113a. The pressing surfaces 151a adjacent to each other in the circumferential direction of the washer 113a are perpendicular to each other.

The washer 113a is axially mirror symmetric. In other words, the washer 113a has the same shape even if the washer is turned over in the axial direction.

As shown in FIG. 5, the thickness of the washer 113a is thicker than the thickness of the disk valve 66. That is, the washer 113a is thicker than the disk valve 66. The rigidity of the washer 113a is higher than that of the disk valve 66.

FIG. 5 shows a pin member 68a before being crimped, which is the pin member 68 shown in FIG. 2. This pin member 68a is crimped and plastically deformed to become the pin member 68 shown in FIG. 2.

As shown in FIG. 5, the pin member 68a has a shaft portion 161a and a flange portion 162. The pin member 68a is made of metal.

The shaft portion 161a has a cylindrical shape.

An outer peripheral surface 171a of the shaft portion 161a is a cylindrical surface.

The flange portion 162 spreads outward in the radial direction of the shaft portion 161a from one end portion of the shaft portion 161a in the axial direction. The outer peripheral surface of the flange portion 162 is a cylindrical surface. In the flange portion 162, an end surface 165 on the side from which the shaft portion 161a extends in the axial direction is a flat surface spreading perpendicularly to the central axis of the shaft portion 161a. In the flange portion 162, an end surface 166 on the opposite side to the end surface 165 in the axial direction is a flat surface parallel to the end surface 165.

In the method of manufacturing the body valve 30 to assemble the body valve 30 shown in FIG. 2, in other words, in the method of manufacturing the shock absorber 11, a shaft portion inserting step is first performed.

In the shaft portion inserting step, as shown in FIG. 5, the shaft portion 161a of the pin member 68a is inserted radially inward, in this order, into each of the inner peripheral surface 123 of the suppressor disk 102, the inner peripheral surface 122 of the disk 101, each inner peripheral surface 121 of the plurality of disks 105, the inner peripheral surface 81 of the valve body 25, the inner peripheral surface 131 of the disk valve 66, the inner peripheral surface 132 of the disk 111, and the inner peripheral surface 133a of the washer 113a. In other words, in the shaft portion inserting step, the shaft portion 161a of the pin member 68a is disposed on the inner peripheries of the suppressor disk 102, the disk 101, the plurality of disks 105, the valve body 25, the disk valve 66, the disk 111, and the washer 113a. Accordingly, the suppressor disk 102, the disk 101, the plurality of disks 105, the valve body 25, the disk valve 66, the disk 111, and the washer 113a are placed on the end surface 165 of the flange portion 162 in this order. At this time, the valve body 25 is oriented such that the leg portion 37 protrudes from the partition portion 36 toward the flange portion 162 in the axial direction.

Next, a clamping step is performed.

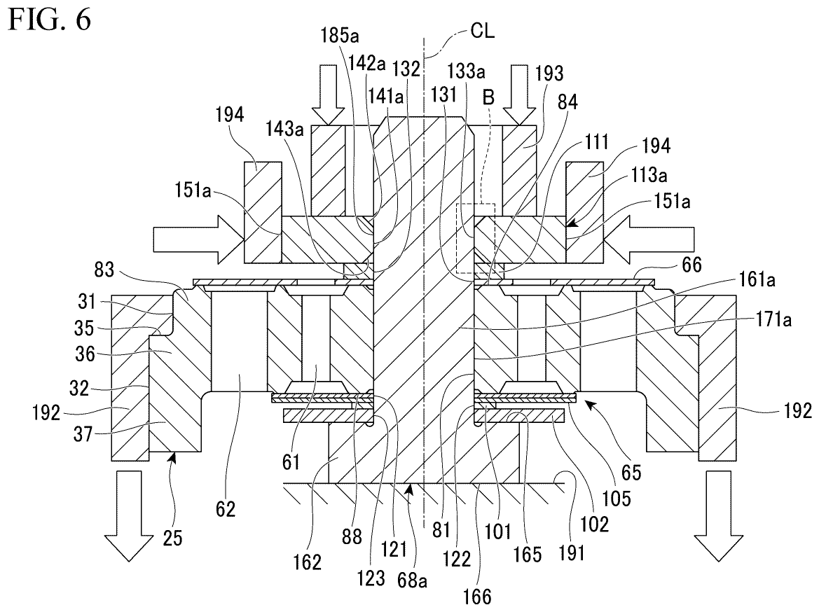

In the clamping step, as shown in FIG. 6, the pin member 68a is placed on a mounting table 191 of a crimping device to come into contact with the end surface 166 of the flange portion 162. Then, a plurality of hook-shaped clamp members 192 of the crimping device are simultaneously brought into contact with the small outer diameter portion 31 and the large outer diameter portion 32 from the radially outer side of the valve body 25. The plurality of clamp members 192 have a hook shape to engage with a step portion 35 between the large outer diameter portion 32 and the small outer diameter portion 31 of the valve body 25. Then, the crimping device pulls the plurality of clamp members 192 downward to clamp the valve body 25, the plurality of disks 105, the disk 101, the suppressor disk 102, and the flange portion 162 of the pin member 68a onto the mounting table 191. This state is the clamped state of the crimping device.

Next, a residual axial force applying step is performed by the crimping device while maintaining the clamped state.

In the residual axial force applying step, a cylindrical axial force applying member 193 of the crimping device pressurizes an end surface on the opposite side to the valve body 25 in the axial direction of the washer 113a toward the valve body 25. Accordingly, the flange portion 162, the suppressor disk 102, the disk 101, the plurality of disks 105, the valve body 25, the disk valve 66, the disk 111, and the washer 113a are clamped by the mounting table 191 and the axial force applying member 193 in the axial direction. In other words, the crimping device applies a residual axial force to the suppressor disk 102, the disk 101, the plurality of disks 105, the valve body 25, the disk valve 66, the disk 111, and the washer 113a. This state is the residual axial force applied state of the crimping device. The shaft portion 161a of the pin member 68a is aligned with the washer 113a in the axial direction so that a part of the shaft portion 161a that faces the washer 113a in the radial direction becomes a facing portion 185a.

Next, a pressing step is performed by the crimping device while maintaining the clamped state and the residual axial force applied state. Furthermore, this pressing step can be performed in parallel with the residual axial force applying step, in other words, simultaneously with the residual axial force applying step.

In the pressing step, a pressing portion 194 of the crimping device presses the washer 113a radially inward toward the shaft portion 161a of the pin member 68a. Here, the crimping device includes the plurality of pressing portions 194, specifically, four pressing portions 194, the same number as the pressing surfaces 151a, at equal intervals to surround the washer 113a from the outside in the radial direction of the washer 113a. Then, the four pressing portions 194 are simultaneously moved inward along the radial direction of the washer 113a and the shaft portion 161a. At this time, the washers 113a are arranged so that the pressing surfaces 151a spread perpendicularly to the travel direction of the pressing portions 194 that correspond to them one-to-one. Then, the four pressing portions 194 simultaneously press the washer 113a radially inward to allow the washer 113a and the shaft portion 161a to plastically deform radially inward. In other words, the washer 113a is pressed horizontally from four directions until the washer bites into the shaft portion 161a. This state is a pressed state of the crimping device.

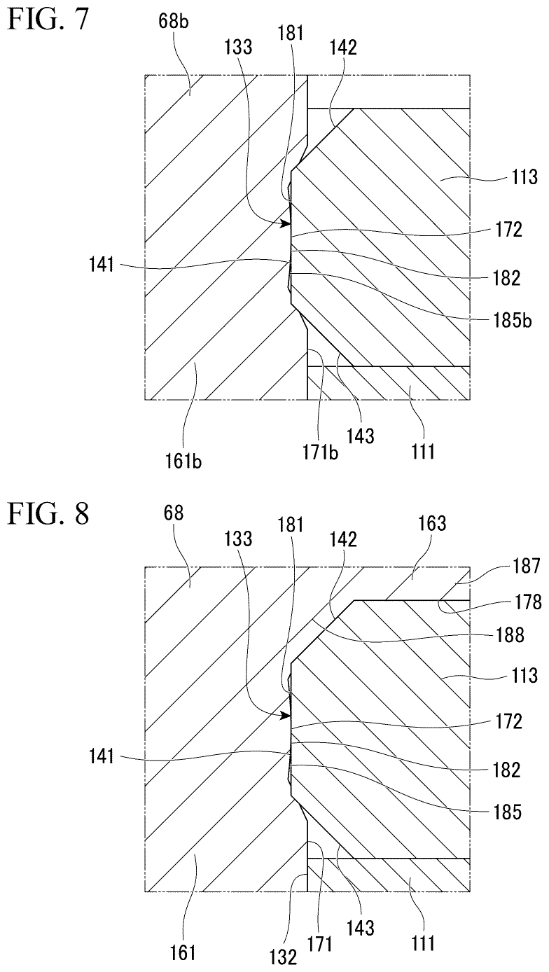

The pin member 68a shown in FIGS. 5 and 6 becomes a pin member 68b shown in FIG. 7 by performing the pressing step. In the pin member 68b, a shaft portion 161b has an outer peripheral surface 171b and a concave portion 172. The outer peripheral surface 171b is a cylindrical surface having the same diameter as the outer peripheral surface 171a shown in FIGS. 5 and 6 before the pressing step. The concave portion 172 shown in FIG. 7 is formed by the pressing step. The concave portion 172 is recessed radially inward in the outer peripheral portion 171b from a middle position of the outer peripheral surface 171b in the axial direction. Accordingly, the outer diameter of the part provided with the concave portion 172 in the shaft portion 161b of the pin member 68b is smaller than the outer diameter of the part other than the concave portion 172 in the axial direction of the pin member 68b. In other words, the distance from the central axis of the outer peripheral surface 171b of the shaft portion 161b of the pin member 68b to the concave portion 172 is smaller than the radius of the outer peripheral surface 171b other than the concave portion 172 of the pin member 68b. The shaft portion 161b has the plurality of, specifically, four concave portions 172 formed at intervals in the circumferential direction of the shaft portion 161b.

The washer 113a shown in FIGS. 5 and 6 is plastically deformed by the pressing step to become the washer 113 shown in FIG. 7. The inner peripheral surface 133a of the washer 113 shown in FIGS. 5 and 6 before the plastic deformation becomes an inner peripheral surface 133 that fits into the concave portion 172 of a shaft portion 161 after the plastic deformation. After the plastic deformation of the washer 113, the small diameter portion 141a shown in FIGS. 5 and 6 becomes a small diameter portion 141 shown in FIG. 7, the large diameter portion 142a shown in FIGS. 5 and 6 becomes a large diameter portion 142 shown in FIG. 7, and the large diameter portion 143a shown in FIGS. 5 and 6 becomes a large diameter portion 143 shown in FIG. 7.

The small diameter portion 141 is provided at the center of the inner peripheral surface 133 in the thickness direction of the washer 113. In other words, the small diameter portion 141 is located at the center of the washer 113 in the axial direction. The distance from the radial central axis of the washer 113 to a minimum inner diameter portion 181 of the small diameter portion 141 is smallest, and is smaller than the radius of the inner peripheral surface 81 of the valve body 25 shown in FIG. 2. Since each of the plurality of, specifically, four pressing surfaces 151a shown in FIG. 3 is pressed in the pressing step, the plurality of, specifically, four minimum inner diameter portions 181 are formed at intervals in the circumferential direction of the small diameter portion 141 in the small diameter portion 141 shown in FIG. 7. By the pressing step, the minimum inner diameter portion 181 of the small diameter portion 141 of the washer 113 forms a concave bottom surface 182 of the concave portion 172 of the pin member 68b. Thus, even after the pressing step, the minimum inner diameter portion 181 of the small diameter portion 141 of the washer 113 comes into contact with the concave bottom surface 182.

In the washer 113, since the minimum inner diameter portion 181 of the small diameter portion 141 comes into contact with the concave bottom surface 182 of the concave portion 172, the radial gap between the pin member 68b and the washer 113 at the position of the minimum inner diameter portion 181 is smaller than the radial gap between the pin member 68 and the valve body 25 shown in FIG. 2.

Each of the pressing surfaces 151a of the washer 113a shown in FIGS. 3 to 6 becomes a pressing surface 151 of the washer 113 shown in FIG. 2 by the pressing step.

As shown in FIG. 7, the large diameter portion 142 of the washer 113 spreads away from each other in the axial direction of the washer 113 while increasing in diameter from one end portion of the small diameter portion 141 in the axial direction of the washer 113. The large diameter portion 142 has a tapered shape.

The large diameter portion 143 spreads away from each other in the axial direction of the washer 113 while increasing in diameter from the end portion on the opposite side to the large diameter portion 142 in the small diameter portion 141 in the axial direction of the washer 113. The large diameter portion 143 has a tapered shape.

The concave portion 172 of the shaft portion 161b is aligned with the inner peripheral surface 133 of the washer 113 in the axial direction of the shaft portion 161b and faces the inner peripheral surface 133 of the washer 113 in the radial direction. The pin member 68b has a facing portion 185b which faces the pin member 68b in the radial direction by aligning the axial position of the pin member 68b with the washer 113. The facing portion 185b is configured by forming the concave portion 172 shown in FIG. 7 in the facing portion 185a of the shaft portion 161a shown in FIG. 6. The concave portion 172 is provided in the facing portion 185b of the pin member 68b. The outer diameter of the pin member 68b at the position of the concave portion 172 of the facing portion 185b of the shaft portion 161b is smaller than the outer diameter of the outer peripheral surface 171b in a part other than the facing portion 185b in the axial direction of the shaft portion 161b of the pin member 68b.

Furthermore, in the pressing step, the concave portion 172 having an annular shape may be formed over the entire circumference of the facing portion 185b. In this case, the small diameter portion 141 fits into the concave portion 172 over the entire circumference and comes into contact with the concave bottom surface 182 of the concave portion 172.

In the washer 113, the large diameter portion 142 is provided on the opposite side to the disk 111 in the axial direction of the washer 113 and has a tapered shape that increases in diameter from the small diameter portion 141 toward the opposite side to the disk 111. Further, the large diameter portion 143 of the washer 113 is provided on the side of the disk 111 in the axial direction of the washer 113 and has a tapered shape that increases in diameter from the small diameter portion 141 toward the disk 111.

By the pressing step, the washer 113a is plastically deformed to become the washer 113.

In the pin member 68a shown in FIG. 6, the axial position is aligned with the washer 113a, and the facing portion 185a that faces the washer in the radial direction is pressed by the washer 113a in the pressing step and is plastically deformed radially inward to become the facing portion 185b shown in FIG. 7. The facing portion 185b is deformed by the pressing step so that the diameter of the concave bottom surface 182 which is the axial center of the shaft portion 161b becomes smallest by the small diameter portion 141 of the washer 113 and the diameters on both axial sides become wider than the small diameter portion 141 by the large diameter portions 142 and 143 of the washer 113.

Next, the crimping step is performed by the crimping device while maintaining the clamped state, the residual axial force applied state, and the pressed state.

In the crimping step, the crimping device uses a punch (not shown) to pressurize and crimp the tip portion of the pin member 68b that protrudes beyond the washer 113 along the axial direction toward the mounting table 191, that is, toward the flange portion 162, thereby forming a disk-shaped crimped portion 163 shown in FIG. 2. That is, in the crimping step, the tip portion on the opposite side to the flange portion 162 shown in FIGS. 5 and 6 in the axial direction of the shaft portion 161b shown in FIG. 7 is plastically deformed in the axial direction to spread radially outward, thereby forming the crimped portion 163 shown in FIG. 2. As a result, the pin member 68b shown in FIG. 7 becomes the pin member 68 shown in FIG. 2. In the crimping step, the crimped portion 163 has a contact surface portion 178 which has a flat plate shape by following the shape of the end surface on the side of the crimped portion 163 in the axial direction of the washer 113.

Here, when the pressing step is performed, the pin member 68b shown in FIG. 7 is plastically deformed to be in a pressed state in such a manner that the facing portion 185b of the shaft portion 161b is pressed radially inward by the washer 113. When an axial load for crimping is applied to the pin member 68b by the crimping step in this pressed state, the material of the shaft portion 161b above the washer 113 is blocked by the washer 113 and is less likely to move below the washer 113. Accordingly, it is possible to mold the crimped portion 163 shown in FIG. 2 while suppressing the radial expansion of the part of the pin member 68b below the washer 113 in the axial direction.

That is, the radial expansion of the pin member 68b shown in FIG. 7 during crimping occurs because the material of the shaft portion 161b escapes below the washer 113 through the radial gap between the washer 113 and the shaft portion 161b of the pin member 68b. In response to this, the pressing step of pressing the washer 113a shown in FIG. 6 into the shaft portion 161a is added so that the washer 113 bites into the shaft portion 161b as shown in FIG. 7. Accordingly, in the crimping step which is a press step subsequent to the pressing step, the material of the shaft portion 161b is less likely to escape to the lower side of the washer 113, that is, toward the valve body 25 shown in FIG. 2. Therefore, the radial expansion of the shaft portion 161 caused by molding the crimped portion 163 can be suppressed.

As described above, the pin member 68 integrates the suppressor disk 102, the disk 101, the plurality of disks 105, the valve body 25, the disk valve 66, the disk 111, and the washer 113 by performing the shaft portion inserting step, the clamping step, the residual axial force applying step, the pressing step, and the crimping step. As a result, the body valve 30 is assembled.

The body valve 30 in an assembled state will be described below.

In the body valve 30, the flange portion 162 of the pin member 68 comes into surface contact with the suppressor disk 102 in the end surface 165, and the crimped portion 163 of the pin member 68 comes into surface contact with the washer 113 in the contact surface portion 178, thereby sandwiching the components from the suppressor disk 102 to the washer 113. In other words, in the body valve 30, the flange portion 162 and the crimped portion 163 of the pin member 68 sandwich the suppressor disk 102, the disk 101, the plurality of disks 105, the valve body 25, the disk valve 66, the disk 111, and the washer 113 while applying a residual axial force from both axial sides. That is, the residual axial force applied to the suppressor disk 102, the disk 101, the plurality of disks 105, the valve body 25, the disk valve 66, the disk 111, and the washer 113 by the residual axial force applying step remains in the body valve 30.

As shown in FIG. 8, the pin member 68 has a shape in which the shaft portion 161 has an outer peripheral surface 171 and the concave portion 172. The outer peripheral surface 171 is a cylindrical surface having the same diameter as the outer peripheral surface 171a shown in FIGS. 5 and 6 before the pressing step and the outer peripheral surface 171b shown in FIG. 7 before the crimping step. As shown in FIG. 8, the concave portion 172 is recessed inward in the radial direction of the outer peripheral surface 171 from the outer peripheral surface 171. Accordingly, the outer diameter of the part provided with the concave portion 172 of the pin member 68 is smaller than the outer diameter of the part other than the concave portion 172 in the axial direction of the pin member 68. In other words, the distance from the central axis of the outer peripheral surface 171 of the shaft portion 161 to the concave bottom surface 182 of the concave portion 172 is smaller than the radius of the outer peripheral surface 171 other than the concave portion 172 of the shaft portion 161. The shaft portion 161 has the plurality of, specifically, four concave portions 172 formed at intervals in the circumferential direction of the shaft portion 161.

The inner peripheral surface 133 of the washer 113 enters into and comes into contact with the concave portion 172 of the shaft portion 161. In the inner peripheral surface 133, the minimum inner diameter portion 181 of the small diameter portion 141 enters into the concave portion 172 and comes into contact with the concave bottom surface 182 of the concave portion 172. Therefore, the radial gap between the shaft portion 161 of the pin member 68 and the minimum inner diameter portion 181 of the washer 113 is smaller than the radial gap between the valve body 25 and the shaft portion 161 shown in FIG. 2.

As shown in FIG. 8, the pin member 68 has a facing portion 185 which faces the washer 113 in the radial direction and aligns with the axial position of the pin member 68. The pin member 68 has the concave portion 172 provided at the facing portion 185. The outer diameter at the position of the concave portion 172 of the facing portion 185 of the pin member 68 is smaller than the outer diameter of the part other than the facing portion 185 in the axial direction of the pin member 68.

The crimped portion 163 of the pin member 68 has a pressure plate portion 187 and an excess material portion 188.

The pressure plate portion 187 has a flat plate shape and has the contact surface portion 178.

The excess material portion 188 protrudes from the radially inner side of the contact surface portion 178 toward the large diameter portion 142 and comes into contact with the large diameter portion 142. The excess material portion 188 is formed in such a manner that the shaft portion 161b shown in FIG. 7 protrudes to bury a gap with the large diameter portion 142 of the washer 113 by the crimping step.

Furthermore, the concave portion 172 may be formed in an annular shape over the entire circumference of the facing portion 185. In this case, the small diameter portion 141 enters into the concave portion 172 over the entire circumference and comes into contact with the concave bottom surface 182 of the concave portion 172.

As shown in FIG. 2, in the washer 113, the large diameter portion 142 is provided on the side of the crimped portion 163 in the axial direction of the washer 113 and has a tapered shape that increases in diameter from the small diameter portion 141 toward one side. Further, in the washer 113, the large diameter portion 143 is provided on the side of the valve body 25 in the axial direction of the washer 113 and has a tapered shape that increases in diameter from the small diameter portion 141a toward the valve body 25.

In the pin member 68, the flange portion 162 has a disk shape that spreads from one axial end portion of the shaft portion 161 toward the radially outer side of the shaft portion 161. The end surface 165 of the flange portion 162 is a flat surface that spreads perpendicularly to the central axis of the outer peripheral surface 171 of the shaft portion 161.

In the pin member 68, the crimped portion 163 is provided at the end portion on the opposite side to the flange portion 162 in the axial direction of the shaft portion 161. The outer diameter of the crimped portion 163 is larger than the outer diameter of the shaft portion 161. In the crimped portion 163, the contact surface portion 178 on the side of the flange portion 162 in the axial direction of the pressure plate portion 187 is a flat surface that spreads perpendicularly to the central axis of the outer peripheral surface 171 of the shaft portion 161.

The pin member 68 has the flange portion 162 provided at one axial end and the crimped portion 163 provided at the other axial end.

In the pin member 68, the shaft portion 161 is disposed on the radially inner side of each of the inner peripheral surface 123 of the suppressor disk 102, the inner peripheral surface 122 of the disk 101, the inner peripheral surface 121 of each of the plurality of disks 105, the inner peripheral surface 81 of the valve body 25, the inner peripheral surface 131 of the disk valve 66, the inner peripheral surface 132 of the disk 111, and the inner peripheral surface 133 of the washer 113. In other words, the pin member 68 is disposed on the inner peripheries of the suppressor disk 102, the disk 101, the plurality of disks 105, the partition portion 36 of the valve body 25, the disk valve 66, and the disk 111. Furthermore, at this time, the valve body 25 is oriented such that the leg portion 37 protrudes from the partition portion 36 toward the opposite side to the crimped portion 163 in the axial direction.

Then, the pin member 68 sandwiches the suppressor disk 102, the disk 101, the plurality of disks 105, the valve body 25, the disk valve 66, the disk 111, and the washer 113 from both axial sides by the flange portion 162 and the crimped portion 163. Accordingly, the suppressor disk 102, the disk 101, the plurality of disks 105, the valve body 25, the disk valve 66, the disk 111, the washer 113, and the pin member 68 are integrated. In other words, the pin member 68 arranges the suppressor disk 102, the disk 101, the plurality of disks 105, the valve body 25, the disk valve 66, the disk 111, and the washer 113 in the axial direction of the pin member 68 to integrate them. At that time, in the pin member 68, the flange portion 162 comes into surface contact with the suppressor disk 102 at the end surface 165, and the crimped portion 163 comes into surface contact with the washer 113 at the contact surface portion 178.

The body valve 30 is of a rivet type in which the suppressor disk 102, the disk 101, the plurality of disks 105, the valve body 25, the disk valve 66, the disk 111, and the washer 113 are integrally connected by the pin member 68 which is a rivet. The pin member 68 sandwiches the suppressor disk 102, the disk 101, the plurality of disks 105, the valve body 25, the disk valve 66, the disk 111, and the washer 113 from both sides in the stacking direction by the flange portion 162 and the crimped portion 163 while applying a residual axial force to integrate them in the axial direction.

The body valve 30 assembled as described above is fitted to one axial end portion of the inner cylinder 15 at the small outer diameter portion 31 of the valve body 25 as shown in FIG. 1 to be assembled to the inner cylinder 15.

In the shock absorber 11, the rod 50 moves in the compression side and the piston 45 moves in the direction of narrowing the second chamber 49. Accordingly, when the pressure in the second chamber 49 becomes higher than the pressure in the reservoir chamber 18, the body valve 30 is deformed such that the outer periphery of the disk valve 65 moves away from the valve body 25 in the axial direction. As a result, the disk valve 65 is lifted off the seat portion 89 shown in FIG. 2 to open the passage 61. Then, the oil L passes through the passage hole 130 of the disk valve 66 and the passage 61 of the valve body 25 shown in FIG. 2 from the second chamber 49 shown in FIG. 1 and flows to the reservoir chamber 18 shown in FIG. 1. The suppressor disk 102 shown in FIG. 2 suppresses the deformation of the disk valve 65 provided between the valve body 25 and the suppressor disk by coming into contact with the disk valve 65.

In the shock absorber 11, the rod 50 shown in FIG. 1 moves toward the extension side and the piston 45 moves toward the first chamber 48. Accordingly, when the pressure in the second chamber 49 becomes lower than the pressure in the reservoir chamber 18, the body valve 30 is deformed such that the outer periphery of the disk valve 66 moves away from the valve body 25 in the axial direction. As a result, the disk valve 66 is lifted off from the outer seat portion 86 shown in FIG. 1 to open the passage 62. Then, the oil L passes through the passage 62 of the valve body 25 from the reservoir chamber 18 shown in FIG. 1 and flows toward the second chamber 49 shown in FIG. 1. When the rod 50 moves toward the extension side, the disk valve 66 opens the passage 62 so that the oil L flows from the reservoir chamber 18 to the second chamber 49 via the passage 62. The washer 113 shown in FIG. 2 suppresses the deformation of the disk valve 66 provided between the washer and the valve body 25 by coming into contact with the disk valve 66.

Here, in the body valve 30, the plurality of disk-shaped disk valves 66 may be stacked. In this case, the plurality of disk valves 66 becomes an extension damping valve that generates a damping force when the oil L flows from the reservoir chamber 18 to the second chamber 49 shown in FIG. 1 through the passage 62. That is, in the shock absorber 11, the body valve 30 may include the disk valve 66 which is at least one disk-shaped valve member.

The above-described Patent Documents 1 and 2 describe hydraulic shock absorbers having a structure in which a pin member having a flange portion on one side is inserted through a valve body and a valve member, and the other side of the pin member is crimped to integrate the valve body and the valve member with the pin member. In a structure in which the pin member is crimped in this way, there is a possibility that stable damping force characteristics may not be obtained. That is, when the pin member is crimped, the material of the pin member moves toward the inner periphery of the valve member to press the valve member radially outward and deform the valve member. Then, a variation in the damping force characteristics occurs. On the other hand, a type in which the valve body and valve member are integrated by crimping the pin member requires fewer components than a type in which the valve body and valve member are integrated with bolts and nuts, and is therefore advantageous in terms of productivity and cost.

The shock absorber 11 of the first embodiment includes the cylinder 17, the piston 45 provided inside the cylinder 17, and the body valve 30 which divides the inside of the cylinder 17 into two chambers, the first chamber 48 and the second chamber 49. Then, the body valve 30 includes the valve body 25, at least one disk-shaped disk valve 66, the washer 113, and the pin member 68. The valve body 25 has the passage 62. The valve member 66 opens and closes the passage 62. The washer 113 is provided on the opposite side to the valve body 25 in the disk valve 66. The washer 113 is thicker than the disk valve 66. The pin member 68 is disposed on the inner peripheries of the disk valve 66 and the washer 113. The pin member 68 has the flange portion 162 provided at one end and the crimped portion 163 provided at the other end. The pin member 68 arranges the valve body 25, the disk valve 66, and the washer 113 in the axial direction to integrate them.

In the body valve 30 of the shock absorber 11, the outer diameter of at least a part of the facing portion 185 facing the washer 113 of the pin member 68 is smaller than the outer diameter of the part other than the facing portion 185 in the axial direction of the pin member 68.

Further, in the body valve 30 of the shock absorber 11, the radial gap between the washer 113 and the pin member 68 is smaller than the radial gap between the valve body 25 and the pin member 68.

The body valve 30 of the shock absorber 11 with such a configuration can be formed by arranging the valve body 25, the disk valve 66, and the washer 113 in the axial direction and integrating them with the pin member 68, including the residual axial force applying step of applying the residual axial force to the valve body 25 and the disk valve 66, the pressing step of pressing the washer 113a toward the pin member 68a before crimping, and the crimping step of forming the crimped portion 163 by crimping.

As described above, since the body valve 30 of the shock absorber 11 is formed by including the pressing step of pressing the washer 113a toward the pin member 68a, the washer 113 pressed toward the pin member 68b can suppress the deformation of the part of the pin member 68b closer to the disk valve 66 than the washer 113 when the crimped portion 163 is formed on the pin member 68b in the crimping step. As a result, the deformation of the disk valve 66 can be suppressed. Thus, the shock absorber 11 can obtain a stable damping force characteristic without variation in the body valve 30. In other words, since the disk valve 66 is a suction valve, the body valve 30 can stably and without variation obtain a characteristic that the disk valve 66 opens without generating substantially any damping force.

Since the body valve 30 of the shock absorber 11 is of a type in which the valve body 25 and the disk valve 66 are integrated by crimping the pin member 68, it requires fewer components than a type in which the valve body 25 and the disk valve 66 are integrated with bolts and nuts, and is therefore advantageous in terms of productivity and cost.

Further, in the body valve 30 of the shock absorber 11, the small diameter portion 141 and the large diameter portions 142 and 143 having a larger diameter than the small diameter portion 141 and provided at different axial positions from the small diameter portion 141 are provided on the inner periphery of the washer 113. Thus, in the pressing step, the pin member 68 can be effectively pressed by the washer 113. Thus, the deformation of the disk valve 66 can be effectively suppressed.

Further, the body valve 30 of the shock absorber 11 has a tapered shape in which the small diameter portion 141 is located at the axial center of the washer 113 and the large diameter portion 142 is provided on the side of the crimped portion 163 in the axial direction of the washer 113 and increases in diameter from the small diameter portion 141 toward the crimped portion 163. Therefore, the washer 113a can be smoothly pressed into the pin member 68a.

Further, the body valve 30 of the shock absorber 11 has a tapered shape in which the large diameter portion 143 is provided on the side of the valve body 25 in the axial direction of the washer 113 and increases in diameter from the small diameter portion 141 toward the valve body 25. Therefore, the washer 113a can be smoothly pressed into the pin member 68a.

Further, in the body valve 30 of the shock absorber 11, the small diameter portion 141 is located at the axial center of the washer 113, the large diameter portion 142 is provided on the side of the crimped portion 163 in the axial direction of the washer 113, and the large diameter portion 143 is provided on the side of the valve body 25 in the axial direction of the washer 113. Therefore, it is possible to make the washer 113a before deformation of the washer 113 have the same shape even when the washer is turned over in the axial direction. Accordingly, it is possible to eliminate the orientation when assembling the washer 113a to the pin member 68a. Thus, since there is no need to check the direction when assembling the washer 113a to the pin member 68a, the assembling becomes easier.

Here, when manufacturing the body valve 30 of the shock absorber 11, if the residual axial force applying step and the pressing step are performed simultaneously in parallel, the time required for assembling the body valve 30 can be shortened.

The first embodiment described above can also be modified as shown in the following first to fourth modified examples.

### First Modified Example

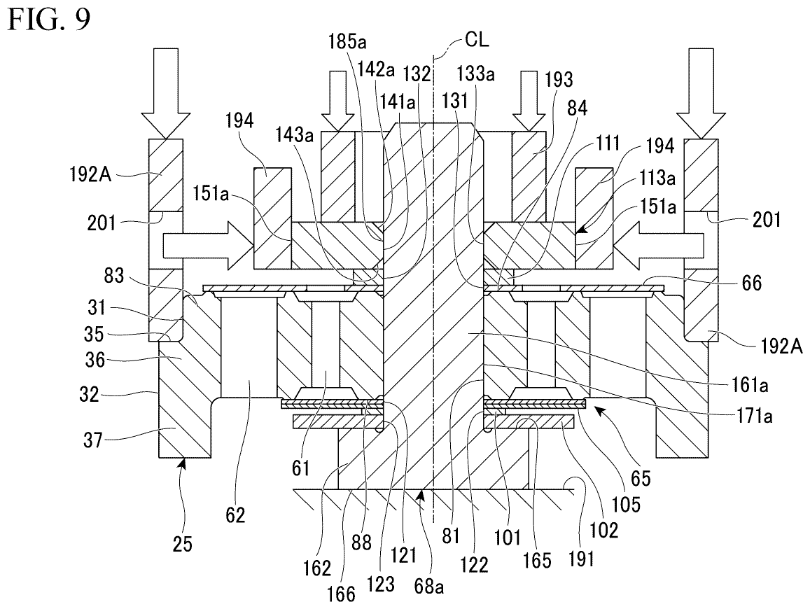

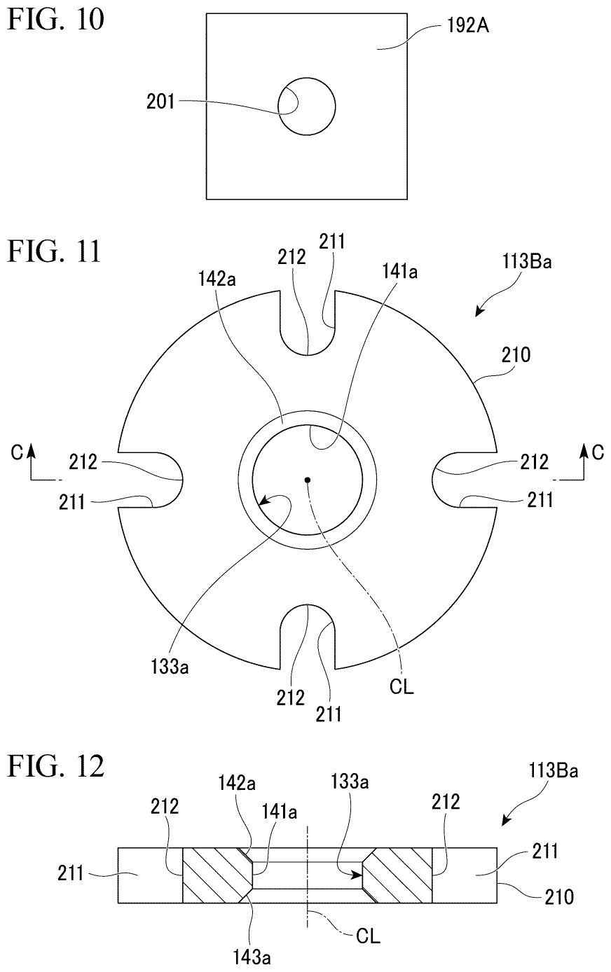

In the first modified example, as shown in FIGS. 9 and 10, a plurality of rectangular plate-shaped clamp members 192A which move along the axial direction of the valve body 25 and come into contact with the step portion 35 are used instead of the plurality of hook-shaped clamp members 192 shown in FIG. 6. Then, the crimping device presses the plurality of clamp members 192A from above to clamp the valve body 25, the plurality of disks 105, the disk 101, the suppressor disk 102, and the flange portion 162 of the pin member 68a to the mounting table 191. The plurality of clamp members 192A are each formed with an insertion hole 201 through which a jig (not shown) for pressing the pressing portion 194 is inserted. Even in the first modified example, the body valve 30 which is the same as that of the first embodiment can be obtained after assembly.

The first modified example also has the same effects as the first embodiment.

### Second Modified Example

In the second modified example, a washer 113Ba shown in FIGS. 11 and 12 is used instead of the washer 113a.

The washer 113Ba has a disk shape and has a pressing groove 211 formed on the outer peripheral portion. The pressing groove 211 extends radially inward from a cylindrical outer peripheral surface 210 of the washer 113Ba. The pressing groove 211 penetrates the washer 113Ba in the axial direction. The pressing groove 211 has an inner end portion 212 on the inside in the radial direction of the washer 113Ba, which has a semi-cylindrical surface shape. The washer 113Ba has the plurality of, specifically, four pressing grooves 211 of the same shape formed at equal intervals in the circumferential direction of the washer 113Ba.

The washer 113Ba is axially mirror symmetric. The thickness of the washer 113Ba is thicker than the thickness of the disk valve 66 shown in FIG. 2. That is, the washer 113Ba is thicker than the disk valve 66. The rigidity of the washer 113Ba is higher than that of the disk valve 66.

This washer 113Ba is also pressed radially inward by four pressing portions (not shown) of the crimping device. At that time, the four pressing portions (not shown) enter into the pressing grooves 211 corresponding to each other in a one-to-one relationship, and come into contact with the inner end portions 212 of the pressing grooves 211. Then, the four pressing portions (not shown) press the inner end portions 212 of the pressing grooves 211 corresponding to each other in a one-to-one relationship inward in the radial direction of the washer 113Ba.

The washer 113Ba also has the inner peripheral surface 133a having the small diameter portion 141a, the large diameter portion 142a, and the large diameter portion 143a. This inner peripheral surface 133a also undergoes the shaft portion inserting step, the clamping step, the residual axial force applying step, and the pressing step to become the inner peripheral surface 133 having the small diameter portion 141, the large diameter portion 142, and the large diameter portion 143. Even when the washer 113Ba is used, the concave portion 172 is formed in the facing portion 185b of the shaft portion 161b of the pin member 68b by the pressing step, and the crimped portion 163 is formed in the pin member 68 by the crimping step.

The washer 113Ba has a disk shape with the cylindrical outer peripheral surface 210. Therefore, a washer formed from the washer 113Ba through the shaft portion inserting step, the clamping step, the residual axial force applying step, the pressing step, and the crimping step has a substantially disk shape and can effectively suppress the deformation of the disk valve 66.

The second modified example also has the same effects as the first embodiment.

Furthermore, in the washer 113Ba, the pressing grooves 211 may be formed at three positions or five or more positions at equal intervals in the circumferential direction of the washer 113Ba.

### Third Modified Example

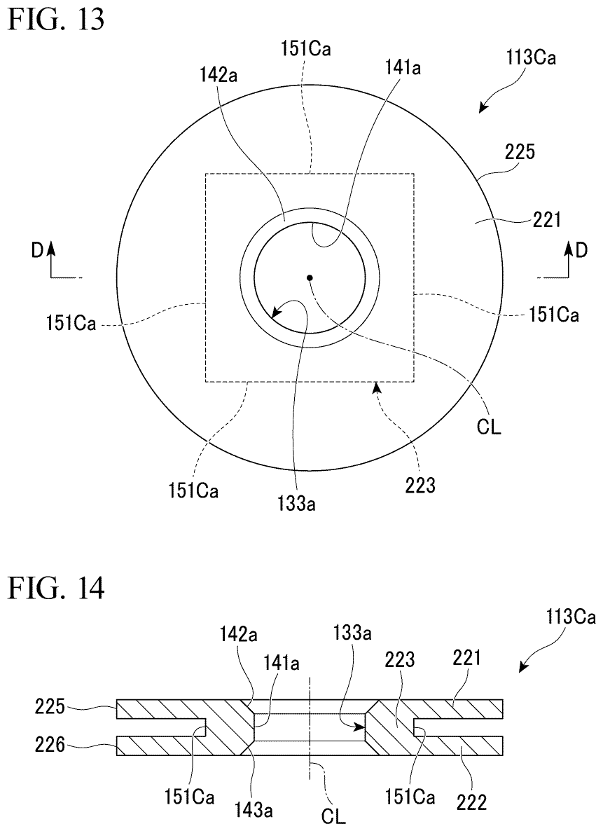

In the third modified example, a washer 113Ca shown in FIGS. 13 and 14 is used instead of the washer 113a.

The washer 113Ca has a disk-shaped portion 221, a disk-shaped portion 222, and a connection portion 223. An outer peripheral surface 225 of the disk-shaped portion 221 is a cylindrical surface. An outer peripheral surface 226 of the disk-shaped portion 222 is a cylindrical surface. The disk-shaped portion 221 and the disk-shaped portion 222 have the same shape.

The disk-shaped portion 221 and the disk-shaped portion 222 are arranged coaxially. In this state, the connection portion 223 is located between the disk-shaped portion 221 and the disk-shaped portion 222 to connect these disk-shaped portions 221 and 222. A pressing surface 151Ca is formed on the outer peripheral portion of the connection portion 223. The pressing surface 151Ca is a flat surface that spreads perpendicularly to the radial direction of the disk-shaped portions 221 and 222. The washer 113Ca has the plurality of, specifically, four pressing surfaces 151Ca of the same shape formed at equal intervals in the circumferential direction. The pressing surfaces 151Ca adjacent to each other in the circumferential direction of the washer 113a are perpendicular to each other.

The washer 113Ca is axially mirror symmetric. In the washer 113Ca, the thickness of each of the disk-shaped portion 221 and the disk-shaped portion 222 is thicker than the thickness of the disk valve 66. That is, the washer 113Ca is thicker than the disk valve 66. The rigidity of the washer 113Ca is higher than that of the disk valve 66.

This washer 113Ca is also pressed radially inward by four pressing portions (not shown) of the crimping device. At that time, the four pressing portions of the crimping device enter between the disk-shaped portion 221 and the disk-shaped portion 222 and come into contact with the pressing surfaces 151Ca that correspond to each other in a one-to-one manner in a vertical direction. Then, the four pressing portions press the corresponding pressing surfaces 151Ca in a one-to-one relationship inward in the radial direction of the washer 113Ca.

The washer 113Ca also has the inner peripheral surface 133a having the small diameter portion 141a, the large diameter portion 142a, and the large diameter portion 143a. After the pressing step, the inner peripheral surface 133a also becomes the inner peripheral surface 133 having the small diameter portion 141, the large diameter portion 142, and the large diameter portion 143. The washer 113Ca also forms the concave portion 172 in the facing portion 185b of the shaft portion 161b of the pin member 68b by the shaft portion inserting step, the clamping step, the residual axial force applying step, and the pressing step and forms the crimped portion 163 in the shaft portion 161 by the crimping step.

The washer 113Ca is a disk-shaped washer having cylindrical outer peripheral surfaces 225 and 226. Therefore, a washer formed from the washer 113Ca through the shaft portion inserting step, the clamping step, the residual axial force applying step, the pressing step, and the crimping step has a disk shape and can effectively suppress the deformation of the disk valve 66.

The third modified example also has the same effects as the first embodiment.

Furthermore, in the washer 113Ca, the pressing surface 151Ca may be formed into a cylindrical surface shape coaxial with the outer peripheral surfaces 225 and 226 of the disk-shaped portions 221 and 222.

### Fourth Modified Example

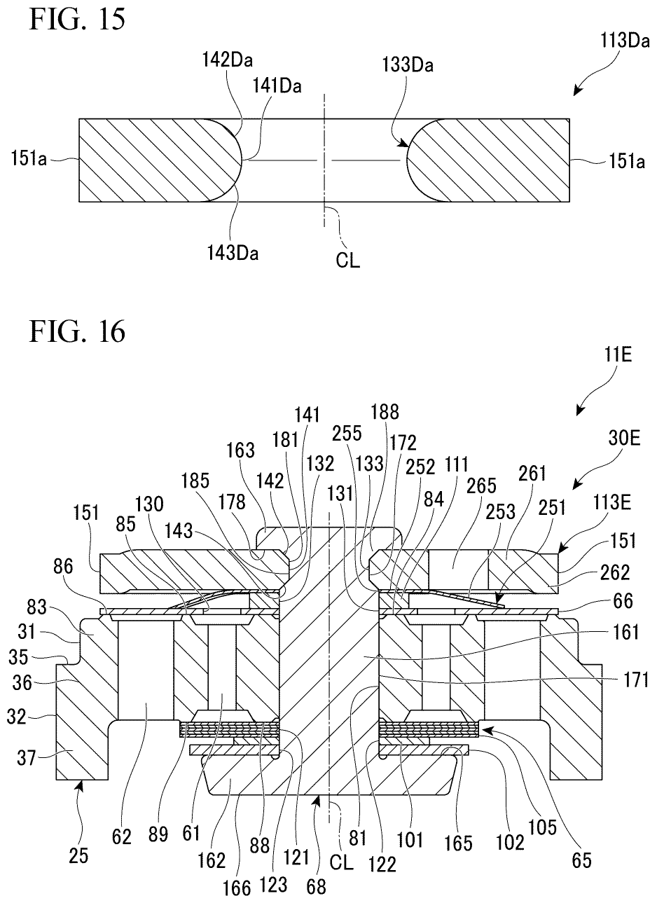

In the fourth modified example, a washer 113Da shown in FIG. 15 is used instead of the washer 113a.

In the washer 113Da, an inner peripheral surface 133Da located at the radial center is different from the inner peripheral surface 133a. The inner peripheral surface 133Da has a circular shape when viewed from the thickness direction of the washer 113Da. The inner peripheral surface 133Da has a cross section in a plane passing through the center of the circle and extending in the thickness direction of the washer 113Da, which is an arc shape, specifically a semicircle shape. The inner peripheral surface 133Da has a small diameter portion 141Da at the center in the thickness direction of the washer 113Da. The inner peripheral surface 133Da has a large diameter portion 142Da on one side relative to the small diameter portion 141Da in the thickness direction of the washer 113Da. The inner peripheral surface 133Da has a large diameter portion 143Da on the other side relative to the small diameter portion 141Da in the thickness direction of the washer 113Da.

The diameter of the small diameter portion 141Da is equal to the diameter of the inner peripheral surface 81 of the valve body 25.

The large diameter portion 142Da spreads away from the small diameter portion 141Da toward one side in the thickness direction of the washer 113Da while increasing in diameter. The large diameter portion 142Da is a curved surface.

The large diameter portion 143Da spreads away from the small diameter portion 141Da toward the other side in the thickness direction of the washer 113Da while increasing in diameter. The large diameter portion 143Da is a curved surface.

The small diameter portion 141Da and the large diameter portions 142Da and 143Da have the same central axis. This central axis is the central axis of the inner peripheral surface 133Da. The inner peripheral surface 133Da is located at the radial center of the washer 113Da. The central axis of the inner peripheral surface 133Da coincides with the central axis of the washer 113Da. The axial direction of the washer 113Da coincides with the thickness direction of the washer 113Da. The small diameter portion 141Da is located at the axial center of the washer 113Da.

The small diameter portion 141Da and the large diameter portions 142Da and 143Da having a larger diameter than the small diameter portion 141Da and provided at a different position from the small diameter portion 141Da in the axial direction of the washer 113Da are provided on the inner periphery of the washer 113Da.

The washer 113Da is axially mirror symmetric. The thickness of the washer 113Da is thicker than the thickness of the disk valve 66. The rigidity of the washer 113Da is higher than that of the disk valve 66.

This washer 113Da is also pressed radially inward by the four pressing portions 194 of the crimping device. At that time, the four pressing portions 194 of the crimping device move in the vertical direction to come into contact with the pressing surfaces 151a which correspond to each other in a one-to-one relationship. Then, the four pressing portions 194 press the pressing surfaces 151a corresponding to each other in a one-to-one relationship inward in the radial direction of the washer 113Da.

The washer 113Da is formed in the pin member 68b by the pressing step to have a concave portion having a different cross-sectional shape in a plane including the central axis of the shaft portion 161b, compared to the concave portion 172 of the shaft portion 161b of the pin member 68b described above. The concave portion has a cross-sectional shape of an arc in a plane including the central axis of the shaft portion to follow the shape of the inner peripheral surface 133Da of the washer 113Da. The outer diameter at the position of the concave portion provided in the facing portion of the shaft portion of the pin member is smaller than the outer diameter of the part other than the facing portion in the axial direction of the pin member. The minimum distance from the central axis of the shaft portion of the pin member to the concave portion is smaller than the radius of the outer peripheral surface of the pin member other than the concave portion.

In the washer (hereinafter, referred to as the washer after the crimping step) formed through the shaft portion inserting step, the clamping step, the residual axial force applying step, the pressing step, and the crimping step of the washer 113Da, the inner peripheral surface 133Da becomes an inner peripheral surface which enters into and comes into contact with the concave portion.

In the washer after the crimping step, the small diameter portion 141Da of the washer 113Da becomes a small diameter portion, the large diameter portion 142Da of the washer 113Da becomes a large diameter portion, and the large diameter portion 143Da of the washer 113Da becomes a large diameter portion. The small diameter portion of the washer after the crimping step is provided at the center of the inner peripheral surface in the thickness direction of the washer. In the washer after the crimping step, one large diameter portion is provided on the side of the crimped portion 163 in the axial direction of the washer and has a curved shape that increases in diameter from the small diameter portion toward one side. Further, in the washer after the crimping step, the other large diameter portion is provided on the side of the valve body 25 in the axial direction of the washer and has a curved shape that increases in diameter from the small diameter portion toward the valve body 25.

In the washer after the crimping step, the minimum inner diameter portion of the small diameter portion enters into the concave portion of the pin member and comes into contact with the concave bottom portion of the concave portion. Thus, the radial gap between the washer and the pin member at the position of the minimum inner diameter portion is smaller than the radial gap between the valve body 25 and the pin member.

The fourth modified example also has the same effects as the first embodiment.

Furthermore, the inner peripheral surface 133a of the washer 113Ba may have the same shape as the inner peripheral surface 133Da of the washer 113Da. Further, the inner peripheral surface 133a of the washer 113Ca may have the same shape as the inner peripheral surface 133Da of the washer 113Da.

### Second Embodiment

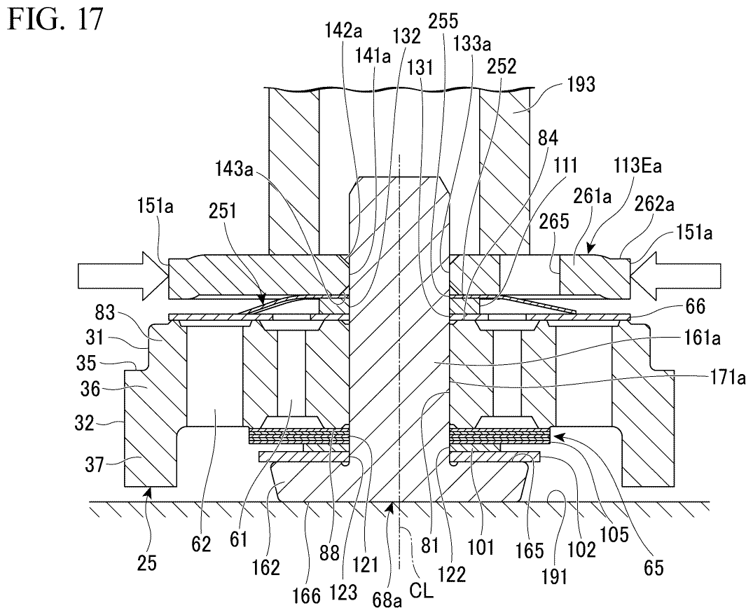

Next, a second embodiment will be described mainly with reference to FIGS. 16 and 17, focusing on the differences from the first embodiment. Furthermore, the same parts as those in the first embodiment are designated by the same names and the same reference numerals.

In the second embodiment, as shown in FIG. 16, a shock absorber 11E includes a body valve 30E which is partially different from the body valve 30.

The body valve 30E includes a spring disk 251 on the opposite side to the disk valve 66 of the disk 111.

The spring disk 251 is made of metal. The spring disk 251 includes a base plate portion 252 and a spring plate portion 253.

The base plate portion 252 has a perforated circular flat plate shape.

An inner peripheral surface 255 of the base plate portion 252 is an inner peripheral surface of the spring disk 251. The diameter of the inner peripheral surface 255 is equal to the diameter of the inner peripheral surface 81 of the valve body 25.

The spring plate portion 253 extends from the outer peripheral portion of the base plate portion 252 toward the radially outer side of the base plate portion 252. The spring plate portion 253 moves away from the base plate portion 252 in the axial direction of the base plate portion 252 as it moves away from the base plate portion 252 in the radial direction of the base plate portion 252.

The spring disk 251 has the plurality of spring plate portions 253 of the same shape formed at equal intervals in the circumferential direction of the base plate portion 252. In the spring disk 251, the base plate portion 252 comes into contact with the opposite side to the disk valve 66 in the axial direction of the disk 111. At that time, in the spring disk 251, the plurality of spring plate portions 253 come into contact with the disk valve 66.

The body valve 30E includes a washer 113E (restricting member) on the opposite side to the disk 111 in the axial direction of the base plate portion 252 of the spring disk 251.

The washer 113E is made of metal and has a perforated circular plate shape, that is, a disk shape.

The washer 113E has a base plate portion 261 and an outer peripheral plate portion 262.

The base plate portion 261 has a perforated circular flat plate shape. The base plate portion 261 has a through hole 265 that penetrates the base plate portion 261 in the axial direction of the base plate portion 261. The base plate portion 261 has the plurality of through holes 265 formed at equal intervals in the circumferential direction. The through hole 265 is disposed on the outside of the base plate portion 252 of the spring disk 251 in the radial direction of the base plate portion 261.

The outer peripheral plate portion 262 has an annular shape and is formed on the radially outer side of the base plate portion 261. The outer peripheral plate portion 262 is formed in an annular shape to surround the radially outer side of the base plate portion 261. The outer peripheral plate portion 262 is offset to one axial side relative to the base plate portion 261. The outer peripheral plate portion 262 protrudes from the base plate portion 261 toward one axial side.

FIG. 17 shows a washer 113Ea before being assembled to the body valve 30E. When the washer 113Ea is assembled to the body valve 30E, the washer is plastically deformed to become the washer 113E.

The washer 113Ea has a base plate portion 261a and an outer peripheral plate portion 262a. The base plate portion 261a has a perforated circular flat plate shape. The outer peripheral plate portion 262a has an annular shape and is formed on the radially outer side of the base plate portion 261a. The outer peripheral plate portion 262a is formed in an annular shape to surround the radially outer side of the base plate portion 261a. The outer peripheral plate portion 262a is offset to one axial side relative to the base plate portion 261a. The outer peripheral plate portion 262a protrudes from the base plate portion 261a toward one axial side.

The washer 113Ea has the inner peripheral surface 133a which is the same as that of the washer 113a at the center of the base plate portion 261a which is the radial center thereof. In the inner peripheral surface 133a, the large diameter portion 143a of the large diameter portion 142a and the large diameter portion 143a is disposed on the protruding side of the outer peripheral plate portion 262a in the axial direction of the washer 113Ea.

The washer 113Ea has the plurality of pressing surfaces 151a which are the same as those of the washer 113a in the outer peripheral portion of the outer peripheral plate portion 262a which is the outer peripheral portion thereof.

The thickness of the washer 113Ea is thicker than the thickness of the disk valve 66. That is, the washer 113Ea is thicker than the disk valve 66. The rigidity of the washer 113Ea is higher than that of the disk valve 66.

In the method of manufacturing the body valve 30E to assemble the body valve 30E, in other words, in the method of manufacturing the shock absorber 11E, the shaft portion inserting step is first performed.

In the shaft portion inserting step, as shown in FIG. 17, the shaft portion 161a of the pin member 68a is inserted into the radially inner side of each of the inner peripheral surface 123 of the suppressor disk 102, the inner peripheral surface 122 of the disk 101, the inner peripheral surface 121 of each of the plurality of disks 105, the inner peripheral surface 81 of the valve body 25, the inner peripheral surface 131 of the disk valve 66, the inner peripheral surface 132 of the disk 111, the inner peripheral surface 255 of the spring disk 251, and the inner peripheral surface 133a of the washer 113Ea in this order. Accordingly, the suppressor disk 102, the disk 101, the plurality of disks 105, the valve body 25, the disk valve 66, the disk 111, the spring disk 251, and the washer 113Ea are placed on the end surface 165 of the flange portion 162 in this order. At this time, the valve body 25 is oriented such that the leg portion 37 protrudes from the partition portion 36 toward the flange portion 162 in the axial direction. Further, at this time, the spring disk 251 is oriented such that the spring plate portion 253 extends from the base plate portion 252 toward the disk valve 66 and comes into contact with the disk valve 66. Further, at this time, the washer 113Ea is oriented such that the outer peripheral plate portion 262a protrudes from the base plate portion 261a toward the disk valve 66 in the axial direction of the base plate portion 261a.

Next, the residual axial force applying step is performed.

In the residual axial force applying step, the pin member 68a is placed on the mounting table 191 of the crimping device at the end surface 166 of the flange portion 162. In this state, the cylindrical axial force applying member 193 of the crimping device pressurizes the end surface on the opposite side to the valve body 25 in the axial direction of the base plate portion 261 of the washer 113Ea toward the valve body 25. Accordingly, the flange portion 162, the suppressor disk 102, the disk 101, the plurality of disks 105, the valve body 25, the disk valve 66, the disk 111, the spring disk 251, and the washer 113Ea are clamped by the mounting table 191 and the axial force applying member 193 in the axial direction. Accordingly, the residual axial force is applied to the suppressor disk 102, the disk 101, the plurality of disks 105, the valve body 25, the disk valve 66, the disk 111, the spring disk 251, and the washer 113. This state is the residual axial force applied state of the crimping device.

Next, the pressing step is performed while maintaining the residual axial force applied state. Alternatively, the pressing step is performed in parallel with the residual axial force applying step.

In the pressing step, the four pressing portions of the crimping device press the washer 113Ea radially inward toward the shaft portion 161a of the pin member 68a, thereby plastically deforming the washer 113Ea and the shaft portion 161a radially inward as in the first embodiment. Accordingly, the washer 113Ea becomes the washer 113E, and the pin member 68a becomes the pin member 68b.

Next, the crimping step is performed while maintaining the residual axial force applied state and the pressed state.

In the crimping step, the crimping device uses a punch (not shown) to pressurize the tip portion of the pin member 68b that protrudes beyond the washer 113E along the axial direction toward the mounting table 191, that is, the flange portion 162, thereby crimping it, thereby forming the disk-shaped crimped portion 163 shown in FIG. 16.

In this way, the pin member 68a shown in FIG. 17 becomes the pin member 68 shown in FIG. 16.

As described above, the pin member 68 integrates the suppressor disk 102, the disk 101, the plurality of disks 105, the valve body 25, the disk valve 66, the disk 111, the spring disk 251, and the washer 113E by performing the shaft portion inserting step, the residual axial force applying step, the pressing step, and the crimping step. As a result, the body valve 30E is assembled.

In the assembled body valve 30E, the inner peripheral surface 133 which is the same as that of the washer 113 is formed on the inner periphery of the base plate portion 261 of the washer 113E.

Further, in the assembled body valve 30E, the shaft portion 161 of the pin member 68 has the same shape as that of the first embodiment.

The second embodiment also has the same effects as the first embodiment.

Here, an inner peripheral surface 133Ea of the washer 113Ea of the second embodiment can also be modified like the inner peripheral surface 133Da of the fourth modified example.

Further, the washer 113Ea of the second embodiment may be modified so that the outer peripheral portion is circular and has the plurality of pressing grooves 211 as in the second modified example. In addition, the inner peripheral surface 133a of the washer 113Ea may have the same shape as the inner peripheral surface 133Da of the fourth modified example.

Further, the washer 113Ea of the second embodiment can also be changed to the shape in which the outer peripheral portion is circular and which includes a pair of disk-shaped portions and a connection portion connecting the pair of disk-shaped portions as in the third modified example. In addition, the inner peripheral surface 133a of the washer 113Ea may have the same shape as the inner peripheral surface 133Da of the fourth modified example.

Furthermore, although the body valves 30 and 30E have been described as examples, the present invention can also be applied to the case in which the piston 45 is integrated with the rod 50. For example, when the structure of the body valve 30 is applied to the piston 45, the attachment shaft portion 52 of the rod 50 is formed in the same shape as the shaft portion 161 of the pin member 68. Then, in the shaft portion inserting step, the attachment shaft portion 52 of the rod 50 is inserted into the suppressor disk 102, the disk 101, the plurality of disks 105, the valve body 25, the disk valve 66, the disk 111, and the washer 113 in this order. At that time, the suppressor disk 102 is brought into contact with the end portion on the side of the attachment shaft portion 52 in the axial direction of the main shaft portion 51. Then, in the residual axial force applying step, the washer 113 is pressurized toward the main shaft portion 51 along the axial direction of the rod 50 to apply a residual axial force to components from the suppressor disk 102 to the washer 113. After the residual axial force applying step or in parallel with the residual axial force applying step, the washer 113 is pressed radially inward toward the attachment shaft portion 52 in the pressing step. After the residual axial force applying step and the pressing step, the crimping step is performed to crimp the part of the attachment shaft portion 52 protruding from the washer 113 and to form a crimped portion. Accordingly, the components from the suppressor disk 102 to the washer 113 are integrated by the end portion on the side of the attachment shaft portion 52 in the axial direction of the main shaft portion 51 and the crimped portion formed in the attachment shaft portion 52. In this case, the leg portion 37, the small outer diameter portion 31, and the large outer diameter portion 32 are removed from the valve body 25, the sliding member is attached to the outer peripheral portion of the valve body 25, and the sliding member is fitted into the inner peripheral portion of the inner cylinder 15.

### INDUSTRIAL APPLICABILITY

According to the embodiments and various modified examples of the present invention, it is possible to provide a shock absorber, a shock absorber manufacturing method, a valve, and a valve manufacturing method capable of obtaining stable damping force characteristics. Thus, the industrial applicability is significant.

### REFERENCE SIGNS LIST

11, 11E Shock absorber
17 Cylinder
18 Reservoir chamber (chamber)
25 Valve body
30, 30E Body valve (valve)
45 Piston
49 Second chamber (chamber)
50 Rod
62 Passage (working fluid passage)
66 Disk valve (valve member)
68, 68a Pin member
113, 113a, 113Ba, 113Ca, 113Da, 113E, 113Ea Washer (restricting member)
141, 141a Small diameter portion
142, 142a, 143, 143a Large diameter portion
162 Flange portion
163 Crimped portion
185 Facing portion

1. A shock absorber comprising:
a cylinder;
a piston which is provided inside the cylinder;
a rod which has one end connected to the piston and another end extending from the cylinder; and
a body valve which divides an inside of the cylinder into two chambers,
wherein the body valve includes a valve body which has a working fluid passage, at least one disk-shaped valve member that opens and closes the working fluid passage, a restricting member that is provided on an opposite side to the valve body in the valve member and thicker than the valve member, and a pin member that is disposed on inner peripheries of the valve member and the restricting member, has a flange portion provided at one end and a crimped portion provided at another end, and arranges the valve body, the valve member, and the restricting member in an axial direction to integrate them, and
wherein an outer diameter of a facing portion facing the restricting member in the pin member is smaller than that of a part other than the facing portion in the axial direction of the pin member.

2. The shock absorber according to claim 1,
wherein a small diameter portion and a large diameter portion having a larger diameter than the small diameter portion and provided at a different axial position from the small diameter portion are provided on the inner periphery of the restricting member.

3. The shock absorber according to claim 2,
wherein the small diameter portion is located at an axial center of the restricting member, and
wherein the large diameter portion is provided on the crimped portion side in the axial direction of the restricting member and has a tapered shape that increases in diameter from the small diameter portion toward the crimped portion.

4. The shock absorber according to claim 3,
wherein the large diameter portion is provided on the valve body side in the axial direction of the restricting member and has a tapered shape that increases in diameter from the small diameter portion toward the valve body.

5. A method of manufacturing a shock absorber including a cylinder, a piston provided inside the cylinder, and a body valve dividing an inside of the cylinder into two chambers, the body valve including a valve body having a working fluid passage, at least one disk-shaped valve member opening and closing the working fluid passage, a restricting member provided on an opposite side to the valve body in the valve member and thicker than the valve member, and a pin member disposed on inner peripheries of the valve member and the restricting member, having a flange portion provided at one end and a crimped portion provided at another end, arranging the valve body, the valve member, and the restricting member in an axial direction to integrate them, the method comprising:
a residual axial force applying step of applying a residual axial force to the valve body and the valve member;
a pressing step of pressing the restricting member toward the pin member; and
a crimping step of forming the crimped portion by crimping.

6. The method of manufacturing the shock absorber according to claim 5,
wherein the residual axial force applying step and the pressing step are performed at the same time.

7. A valve used in a shock absorber, comprising:
a valve body which has a working fluid passage;
at least one disk-shaped valve member that opens and closes the working fluid passage;
a restricting member that is provided on an opposite side to the valve body in the valve member and thicker than the valve member; and
a pin member that is disposed on inner peripheries of the valve member and the restricting member, has a flange portion provided at one end and a crimped portion provided at another end, and arranges the valve body, the valve member, and the restricting member in an axial direction to integrate them,
wherein a gap between the restricting member and the pin member is smaller than a gap between the valve body and the pin member.

8. A method of manufacturing a valve used in a shock absorber and including a valve body having a working fluid passage, at least one disk-shaped valve member opening and closing the working fluid passage, a restricting member provided on an opposite side to the valve body in the valve member and thicker than the valve member, and a pin member disposed on inner peripheries of the valve member and the restricting member, having a flange portion provided at one end and a crimped portion provided at another end, and arranging the valve body, the valve member, and the restricting member in an axial direction to integrate them, the method comprising:
a residual axial force applying step of applying a residual axial force to the valve body and the valve member;
a pressing step of pressing the restricting member toward the pin member; and
a crimping step of forming the crimped portion by crimping.
